(19) United States
(12) Patent Application Publication
(10) Pub. No.: US 2024/0403605 A1
(43) Pub. Date: Dec. 5, 2024

(54) MULTIMODAL DEEP LEARNING WITH BOOSTED TREES

(71) Applicant: International Business Machines Corporation, Armonk, NY (US)

(72) Inventors: Penny Chong, Singapore (SG); Laura Wynter, Singapore (SG)

(21) Appl. No.: 18/327,192

(22) Filed: Jun. 1, 2023

(51) Int. Cl. G06N 3/045; G06N 3/047

(52) U.S. Cl. CPC G06N 3/045; G06N 3/047

(57) ABSTRACT

Aspects of the invention include techniques for leveraging a joint knowledge distillation-based approach for multimodal deep learning with boosted trees. A non-limiting example method includes training a plurality of unimodal teacher models. Each unimodal teacher model of the plurality of unimodal teacher models can be trained using training data from a unique modality of a plurality of modalities. For each of the unimodal teacher models, a respective student encoder of a plurality of student encoders is trained using a knowledge distillation such that one or more features for each respective student encoder are forced to a same feature of the respective unimodal teacher model. A concatenation of outputs from the plurality of student encoders are used to train a fusion neural network of the multimodal neural network. Data is received from the plurality of modalities and a prediction is generated from an output layer of the trained fusion neural network.

### BACKGROUND

The present invention generally relates to multimodal data and deep learning techniques, and more specifically, to computer systems, computer-implemented methods, and computer program products for multimodal deep learning with boosted trees.

Large multimodal neural networks are a type of neural network architecture that can process and integrate information from multiple sources or modalities to perform complex machine learning tasks such as natural language understanding, image recognition, and speech recognition. Large multimodal neural networks have been applied to a wide range of tasks, including image captioning, question answering, speech recognition, and language translation.

An objective of these multimodal networks is to combine the strengths of the various input modalities to improve overall task performance. The development of large multimodal neural networks has been driven by advances in deep learning and the availability of large datasets. In recent years, there has been a surge of interest in multimodal learning, which has led to the development of various architectures such as the multimodal transformer, the visual-linguistic transformer, and the multimodal fusion network.

Multimodal data refers to data that consists of multiple modalities, or types of information. In the context of artificial intelligence and machine learning, the most common modalities are text, images, audio, and video. Other modalities include sensor data, such as temperature, humidity, and pressure, and spatial data, such as GPS coordinates.

The use of multimodal data can allow for a more comprehensive and accurate analysis of complex phenomena. For example, in natural language processing, combining text and image data can lead to a more accurate sentiment analysis and named entity recognition, since the context provided by the images can help disambiguate words in the text having multiple meanings. Similarly, in computer vision, combining visual and textual information can improve object recognition and image captioning. In speech recognition, combining audio and text can help disambiguate homophones and has been shown to improve overall recognition accuracy.

Data integration is one of the key challenges in designing large multimodal neural networks—that is, how to effectively combine information from the different modalities within a single machine learning architecture. Conventionally, it has been understood that different data types (i.e., different modalities) work best with different underlying learning model architectures. For example, convolutional neural networks have been shown to give good results for image data, while decision tree-based machine learning models are often used for tabular data, time-series data, and sensor data.

Current approaches to solving multimodal problems generally fall into two categories. The first approach involves designing a large multimodal neural network to use all data modalities jointly. A drawback with this approach is that the resulting model will necessarily be large and prone to modality collapse. In addition, large models of this type do not leverage the best modeling method for each data modality. The second approach breaks the problem down by modality and involves building a number of independently trained models, one for each data modality, and later combining their individual predictions. A drawback with this approach is that, by definition, the separate models do not fully utilize the benefit of joint multimodal data.

### SUMMARY

Embodiments of the present invention are directed to techniques for leveraging a joint knowledge distillation-based approach for multimodal deep learning with boosted trees. A non-limiting example method includes training a plurality of unimodal teacher models. Each unimodal teacher model of the plurality of unimodal teacher models can be trained using training data from a unique modality of a plurality of modalities. For each of the unimodal teacher models, a respective student encoder of a plurality of student encoders is trained using knowledge distillation such that one or more features for each respective student encoder are forced to have the same features as the respective unimodal teacher model. A concatenation of outputs from the plurality of student encoders are used to train a fusion neural network of the multimodal neural network. Data is received from the plurality of modalities and a prediction is generated from an output layer of the trained fusion neural network. Advantageously, building a multimodal neural network architecture in this manner enables the full leveraging of the multimodal data at a reduced risk of modality collapse via the teacher encoders.

In some embodiments, each unimodal teacher model is uniquely coupled, directly or indirectly, to a student encoder. Advantageously, this configuration allows each student encoder to be built from a single teacher model of a single modality while also considering the other modalities jointly, further reducing the risk of modality collapse.

In some embodiments, the plurality of unimodal teacher models includes a convolutional neural network (CNN) teacher and a gradient boosted decision tree (GBDT) teacher. Advantageously, each teacher model can be applied to modalities (e.g., image data and sensor data, respectively) known to be suitable to the respective teacher configuration. In some embodiments, the CNN teacher is coupled to an image student encoder and the GBDT teacher is coupled to a sensor student encoder, allowing each respective student encoder to be built from a teacher trained using data from the same modality.

In some embodiments, a soft-label output is generated from each unimodal teacher model. In some embodiments, knowledge distillation is enforced on the output layer by forcing the output layer to approximate an aggregated probability output (aggregated soft-labels) of the plurality of unimodal teacher models via a loss term of an objective function of the multimodal neural network. Advantageously, enforcing knowledge distillation on the output layer allows for further fine-tuning of the multimodal neural network.

In some embodiments, knowledge distillation includes training a neural network with one or more tree features to approximate a tree group structure of a gradient boosted decision tree (GBDT) teacher. Advantageously, applying knowledge distillation in this manner allows a neural network-based student encoder to be built for a tree-based teacher model at a minimized (within a predefined distance) loss.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block diagram of a multimodal neural network training module in accordance with one or more embodiments of the present invention;

FIG. 3 depicts an example construction of a tree embedding layer for a student encoder in accordance with one or more embodiments of the present invention;

FIG. 4 depicts an example inference for the multimodal neural network in accordance with one or more embodiments of the present invention;

FIG. 5 depicts a graph of FLOPS usage during inference for a variety of machine learning architectures in accordance with one or more embodiments of the present invention;

FIG. 6 depicts a graph of parameter count during inference for a variety of machine learning architectures in accordance with one or more embodiments of the present invention;

FIG. 7 depicts a graph of CPU memory usage during inference for a variety of machine learning architectures in accordance with one or more embodiments of the present invention; and

FIG. 8 is a flowchart in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number correspond to the figure in which its element is first illustrated.

### DETAILED DESCRIPTION

Large multimodal neural networks can process and integrate information from multiple modalities to perform complex machine learning tasks such as image captioning, question answering, speech recognition, and language translation. Data integration is one of the key challenges in designing these large multimodal neural networks.

A single, relatively large multimodal neural network configured to use all data modalities jointly fully leverages joint multimodal data at the cost of model size and at risk of modality collapse. Modality collapse is a phenomenon that can occur in multimodal neural networks where a network learns to rely too heavily on a single modality at the expense of the others, leading to a degradation in overall performance. Specifically, modality collapse occurs when a network assigns low importance or attention to certain modalities, effectively ignoring them, even when those modalities contain useful information for the task. In addition, these types of large models do not leverage the best modeling method for each data modality, as all modalities are subjected to a shared neural network architecture.

One approach to ensure that the best modeling techniques are used for each data modality is to break up a single, relatively large multimodal neural network into a plurality of sub-networks. In particular, a number of independently trained models can be built, one for each data modality, and their individual predictions can be combined later. Unfortunately, the separate models cannot fully utilize the benefit of joint multimodal data, such as, for example, leveraging any relationships between data of different modalities (i.e., cross-modality context).

This disclosure introduces new methods, computing systems, and computer program products for multimodal deep learning with boosted trees. In particular, a joint knowledge distillation-based approach is proposed that combines knowledge from competitive machine learning methods for any number of domains, such as, for the image and sensor domains, the convolutional neural network (CNN) and the gradient boosted decision tree (GBDT), respectively. In some embodiments, a separate teacher model is trained for each modality. For example, a CNN teacher can be trained for an image modality and a GBDT teacher can be trained for a sensor modality. The underlying teacher models (e.g., a CNN teacher, a GBDT teacher, a transformer teacher, etc.) are then used to train respective student encoders of a shared multimodal neural network via knowledge distillation.

As used herein, “knowledge distillation” refers to the fact that, for each modality, the features learned by a respective encoder are enforced to be similar to (i.e., to approximate within a selected threshold) the unimodal teachers via internal feature manipulation. For example, internal knowledge distillation for the image modality can occur during training, where knowledge can be distilled from the internal representation of any layer in the CNN teacher to any layer in the student image encoder by forcing the image encoder to learn (within a tolerable difference threshold) one or more same layerwise features as the CNN teacher. In another example, internal knowledge distillation for the sensor modality can occur by representing a sensor encoder as a relatively simple neural network with selected tree features ϕ^{sensor} [I^{T}] trained to approximate the tree group structure of a GBDT via minimizing the distance between its output and the GBDT embedding vector.

In some embodiments, knowledge distillation is also enforced on the output (predictions) of the shared multimodal neural network. For example, average soft-labels (softened probabilities) from each of the teacher models can be used as additional guidance to train the multimodal network by enforcing the output layer of the multimodal network to approximate the aggregated probability outputs (aggregated soft-labels) of the ensemble of teachers via the loss term of the final objective function of the shared multimodal neural network.

A multimodal machine learning architecture that leverages a joint knowledge distillation-based approach in accordance with one or more embodiments described herein offers various technical advantages over prior approaches to multimodal deep learning. In particular, a joint knowledge distillation-based multimodal neural network natively solves the modality collapse problem and allows the best modeling paradigms to be used for each modality (e.g., for both image and sensor modalities) in the training of the multimodal network.

Notably, no restriction is placed on the number of layers involved nor the type of architecture between the teachers and their respective student encoders. In some embodiments, a projection layer is built between one or more teachers and their respective student encoders. The projection layer permits feature distillation between different vector dimensions, thus enabling a task to be performed jointly on the various modalities using only a single multimodal network. As there is no requirement for a teacher and student encoder to have the same architecture, the student encoder (e.g., a CNN) can have fewer layers (e.g., a lower model complexity) than the teacher model (e.g., another, larger CNN), enabling the production of smaller, yet effective, models that can fit on edge devices in a multimodal setting.

Other advantages are possible. For example, aspects of the present disclosure utilize a student encoder having the same or even a different architecture than their respective teacher. Tree structures, for example, can be approximated using an embedding layer. Likewise, the representations of a neural network (e.g., a CNN) can be learned via internal knowledge distillation using a projection layer if the feature vector dimensions are of different dimensions. In some embodiments, knowledge from the tree structure, approximated by the embedding layer, and knowledge from the internal representations of a CNN teacher, is jointly distilled along with aggregated prediction outputs from the heterogeneous teacher models (i.e., from the CNN teacher and the GBDT teacher).

Advantageously, the resulting shared multimodal neural network retains the performance of its heterogeneous teachers (each with a single model) while jointly leveraging the different data modalities. The heterogeneous teachers are trained over a single modality, reducing risk of modality collapse when they are used as additional guidance to train the multimodal network, which is otherwise common in multimodal learning because different modalities converge at different rates and weaker modalities can end up undertrained. Moreover, shared multimodal neural networks described herein can be derived of any size, for example, for inference at the edge, by selecting an appropriately small architecture for the underlying student encoders of the multimodal target network. Shared multimodal neural networks described herein are also highly flexible, as even the underlying teacher model for a given modality can be replaced as desired (e.g., as new state-of-the-art model architectures are developed). For example, a GBDT sensor teacher can be swapped for a new tree-based teacher using a future state-of-the-art tree architecture shown to provide better (more accurate predictions, faster training, faster predictions, smaller model, less compute time, etc.) results than GBDT.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

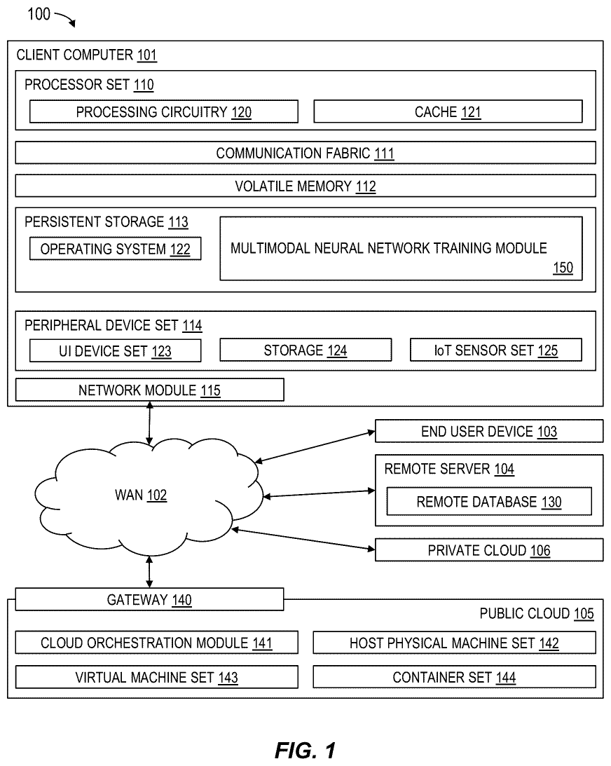

Referring now to FIG. 1, computing environment 100 contains an example of an environment for the execution of at least some of the computer code involved in performing the inventive methods, such as multimodal neural network training module 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

### Multimodal Neural Network Training

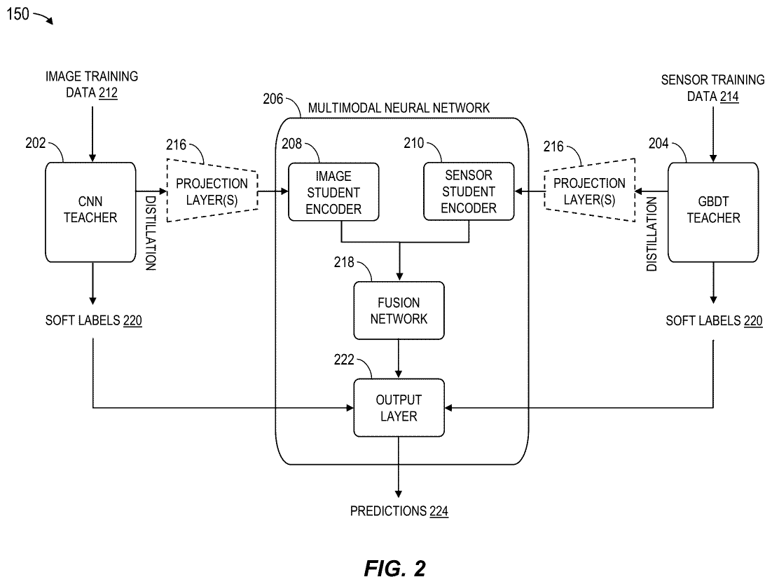

FIG. 2 depicts a block diagram of a multimodal neural network training module 150 in accordance with one or more embodiments of the present invention. In some embodiments, the multimodal neural network training module 150 includes a plurality of unimodal teacher models (here, a CNN teacher 202 and a GBDT teacher 204) coupled to a multimodal neural network 206. The use of a CNN teacher and a GBDT teacher is for ease of discussion and illustration only. It should be understood that the particular teacher model architectures and respective modalities chosen need not be particularly limited. Other architectures and model-modalities combinations are possible, such as a transformer teacher for text and next word prediction, a GBDT teacher for image data, time-series data, tabular data, etc., and all such configurations (including any number of underlying modalities and associated teachers/student encoders) are within the contemplated scope of this disclosure.

In some embodiments, each teacher (e.g., the CNN teacher 202 and the GBDT teacher 204) is uniquely coupled, directly or indirectly, to a student encoder. For example, the CNN teacher 202 can be coupled to an image student encoder 208 and the GBDT teacher 204 can be coupled to a sensor student encoder 210. In some embodiments, for each modality (e.g., image data, sensor data, etc.), the features learned by each student encoder (e.g., the image student encoder 208 and the sensor student encoder 210) are enforced to be similar to the teacher models via internal feature knowledge distillation according to the following procedure.

### Step 1: Teacher Training

In some embodiments, each teacher model is trained over a respective modality. For example, the CNN teacher 202 can be trained over image training data 212 and the GBDT teacher 204 can be trained over the sensor training data 214. Training procedures for various machine learning architectures are known and are not meant to be particularly limited but can include, in general, model selection and initialization, data preparation, loss function selection, optimization, training, hyperparameter tuning, and evaluation.

Model Selection and Initialization: an appropriate model can be selected for each teacher model. In some embodiments, each respective architecture is selected according to domain knowledge (e.g., a model known to be suitable to the given modality). For example, CNNs are often used for image and video data, recurrent neural networks (RNNs) are often used for sequential data, and deep learning architectures such as the transformer are often used for data involving a large corpus of text. Initialization (e.g., layer initialization) involves setting the initial weights of the respective model's layers, and can have a significant impact on a model's ability to learn. There are several techniques for layer initialization, including random initialization, Xavier initialization, He initialization, and initialization based on transfer learning, which can be chosen based on the specific architecture and task.

Data Preparation: one of the first steps in training any machine learning model is to prepare the input data. Data preparation typically involves collecting and cleaning the data, and splitting it into training, validation, and test sets. Data preparation is similar for most machine learning architectures, but the pre-processing steps can differ depending on the type of data being used. For example, for image data, CNNs often require image augmentation techniques to improve the generalization of the model.

Loss Function Selection: the loss function is a measure of how well a model is performing on the task at hand. A loss function is typically selected based on the specific task and architecture used. For example, in regression tasks, the mean squared error (MSE) is often used as the loss function. In other examples, for image classification tasks, CNNs often use cross-entropy loss, while RNNs often use a mean squared error loss for regression tasks. In some deep learning architectures, an additional regularization loss term is added to the loss function to prevent overfitting. Regularization involves adding a penalty term to the loss function that encourages the model to have smaller weights or simpler representations. Some common regularization techniques include L1 and L2 regularization, dropout, and batch normalization, which are typically chosen based on the specific architecture and task.

Optimization: The goal of optimization is to adjust a model's parameters to minimize the loss function. This is typically done using an optimization algorithm such as gradient descent, and can depend on the specific architecture for a given task. For example, CNNs typically use stochastic gradient descent (SGD) with momentum, while RNNs often use adaptive moment estimation.

Training: The model is trained using the training data set, and the loss function is computed on the validation data set to monitor performance and to prevent overfitting. Training is largely architecture-specific. For example, training for CNNs typically involves forward propagation of training data through the convolutional layers and pooling layers, followed by a fully connected layer. Training for RNNs typically involves feeding sequential data through a set of recurrent layers. For other deep learning architectures, training can involve feeding data through multiple layers of various types, such as convolutional, recurrent, or fully connected layers.

Hyperparameter Tuning: Hyperparameters are parameters that are not self-learnable during training, such as the learning rate or the number of layers in a respective model. These hyperparameters can have a significant impact on the performance of the model, and in some cases can themselves be tuned (often using a separate validation data set). Hyperparameters are generally tunable for all architectures, but the specific hyperparameters that are tuned may differ depending on the architecture. For example, for CNNs, the number of filters, filter size, and pooling size are common hyperparameters that are tuned. For RNNs, the number of hidden units, the number of layers, and the learning rate are common hyperparameters that are tuned.

Evaluation: Once the model has been trained and the hyperparameters have been tuned, the model is evaluated on test data to assess predictive performance on unseen data. Model evaluation is somewhat similar for all architectures.

Step 2: Student Training with Knowledge Distillation

For each modality, the features learned by each student encoder are enforced to be similar to the unimodal teachers via an internal feature knowledge distillation. In some embodiments, the mechanism for knowledge distillation depends on the respective teacher model architecture and/or modality type.

### Illustrative Example—Image Features

For internal layer-based distillation, such as for the image features of a CNN teacher, knowledge can be distilled from the CNN teacher model to the student image encoder (which will also be layer and/or CNN-based) during training from the internal representation of any layer in the CNN teacher to any layer in the student image encoder by enforcing the image encoder to learn one or more same layerwise features as the CNN teacher. In some embodiments, a modified objective function is used to enforce similarity in layerwise features. For an image modality, for example, the modified objective function for the joint training of the multimodal neural network 206 is defined according to equation (1):

$${min}_{{θ}_{img} , {w}_{0} , {w}_{1}} {λ}_{0} L ( y , σ ( \hat{y} ) ) + {λ}_{1} {\sum }_{i , j = 1}^{\vert {T}^{img} \vert \vert {ϕ}^{img} \vert} {δ}_{i , j} {L}_{distillImg} ( {T}_{i}^{img} , {ϕ}_{j}^{img} ) \qquad ( 1 )$$

where the term L(y, σ(ŷ)) trains the multimodal network 206 to predict the groundtruth label y, the second term L_{distilling}(Tᵢ^{img},ϕⱼ^{img}) denotes the internal image feature distillation from layer i in the teacher T^{img} (e.g., CNN teacher 202) to layer j in the student encoder ϕ^{img}, Note that, in equation (1), L( [symbol] ) is the cross-entropy loss and L_{distilling} ( [symbol] ) is one or more of squared L₂ regression, cosine loss, and KL divergence for layers involving probability distributions (e.g., attention layers). δ_{i,j}Σ{0, 1} determines the pair(s) of teacher-student layers that take part in the knowledge distillation.

Notably, as opposed to other methods, this technique can be applied to multiple layers-rather than only a single layer-between the teacher and student network. Moreover, this configuration does not require the teacher and the student image encoder to have the same architecture and internal knowledge distillation according to one or more embodiments can therefore be generalized between neural networks of different depths and widths. Generalizing in this manner enables the use of a smaller student encoder than the teacher model (e.g., a student encoder CNN having fewer layers than the teacher model).

Due to possible feature dimension differences between a teacher (e.g., CNN teacher 202) and a student encoder (e.g., image student encoder 208) caused, for example, by each respective model having a different number of widths and depths as described previously, one or more projection layers can be inserted into the distillation points between the teacher and student encoder. For example, a projection layer 216 can be inserted between the CNN teacher 202 and the image student encoder 208.

In some embodiments, the projection layer 216 is configured to project a feature vector (e.g., an output) obtained from the image student encoder 208 to a same dimension as the feature vector obtained from the CNN teacher 202. In some embodiments, projection layer 216 denoted by R(.; w_{reg}) is a convolutional regressor layer with parameters w_{reg} and are trained jointly with one or more other parameters of the multimodal neural network 206. In this configuration, the objective function is further modified as described with respect to equation (2):

$${min}_{{θ}_{img} , {w}_{0} , {w}_{1} , {w}_{reg}} {λ}_{0} L ( y , σ ( \hat{y} ) ) + {λ}_{1} {\sum }_{i , j = 1}^{\vert {T}^{img} \vert \vert {ϕ}^{img} \vert} {δ}_{i , j} {L}_{distillImg} ( {T}_{i}^{img} , R ( {ϕ}_{j}^{img} ; {w}_{reg} ) ) \qquad ( 2 )$$

In some embodiments, a grid search is performed and a guiding layer in the teacher model and a guided layer in the student encoder are chosen for feature distillation (i.e., as the output and input features of the projection layer 216, respectively) based on the pair of layers that gives a best validation performance. Observe that, unlike projection approaches that rely on a stage-wise training scheme (i.e., where a first stage includes training a student network up to the guided layer and a second stage is a knowledge distillation training of the whole network), the present approach (defined according to equation (2)) allows for the whole network to be trained jointly (that is, guided and other layers are simultaneously trained), guided by the teacher's guiding layer and soft-labels. The use of soft-labels is discussed in greater detail below.

### Illustrative Example—Sensor Features

For tree-based architectures, such as for the sensor features of a GBDT teacher, knowledge can be distilled from the GBDT teacher by approximating a tree embedding layer [symbol] for a student sensor encoder. In some embodiments, the student encoder (e.g., the sensor student encoder 210) is represented by a relatively simple neural network with selected tree features ϕ^{sensor} [I^{T}] trained to approximate the tree group structure of a tree-based teacher model (e.g., the GBDT teacher 204) by minimizing the distance between its output and the tree embedding vector according to the equation (3):

$${L}_{distillEmb} ( , {ϕ}^{sensor} [ {I}^{T} ] ) \qquad ( 3 )$$

where L_{distillEmb} ( [symbol] ) is a distance measure (e.g., squared Euclidean distance, Tanimoto distance, Manhattan distance, etc.).

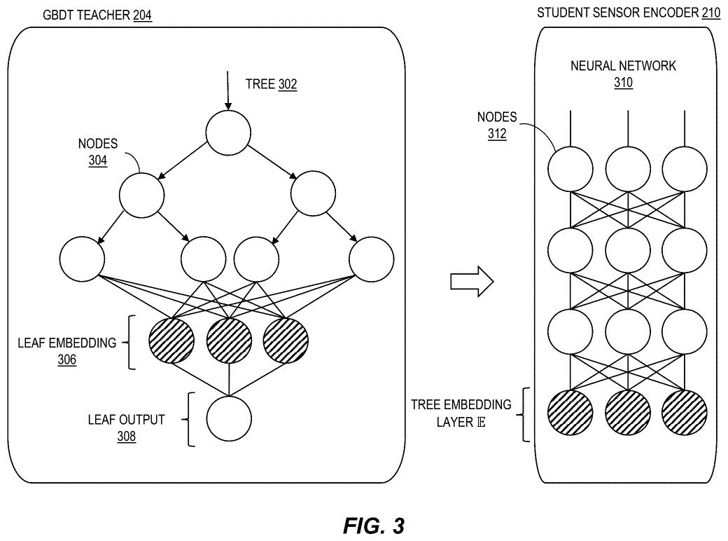

FIG. 3 depicts an example construction of a tree embedding layer [symbol] for the student sensor encoder 210 of FIG. 2 in accordance with one or more embodiments. As shown in FIG. 3, the GBDT teacher 204 can include one or more trees 302 (here, a single tree 302 for ease of illustration) each having a plurality of nodes 304. In some embodiments, the nodes 304 are arranged in branches (layers) as in a directed graph, where the bottommost nodes are fully connected to a leaf embedding layer 306 (as shown). The leaf embedding layer 306 can be mapped to a leaf output 308. As further shown in FIG. 3, the student sensor encoder 210 can include a neural network 310 having a plurality of nodes 312. In some embodiments, the nodes 312 are connected to a tree embedding layer [symbol] having a copy of each node of the leaf embedding layer(s) 306 of the tree(s) 302 of the GBDT teacher 204.

### Step 3: Concatenation

As further shown in FIG. 2, in some embodiments, each of the student encoders (e.g., the image student encoder 208 and the sensor student encoder 210) is coupled to a fusion network 218. In some embodiments, respective outputs from each of the student encoders are concatenated into a single input to the fusion network 218. In some embodiments, the concatenation of outputs from the plurality of student encoders is used to train the fusion neural network 218 of the multimodal neural network 206. In some embodiments, the fusion of modality-specific features from the respective encoders enables the fusion network 218, which is part of the multimodal network 206, to fully leverage the benefit of joint multimodal data in its prediction.

### Step 4: Output Guidance

In some embodiments, knowledge distillation includes a soft-label knowledge distillation from all teachers (e.g., the CNN teacher 202 and GBDT teacher 204) for all modalities (e.g., for image and sensor modalities). In some embodiments, average soft-labels 220 (softened probabilities) of the various teacher models are leveraged to further train the multimodal neural network 206.

In some embodiments, knowledge distillation is enforced on an output layer 222 of the multimodal neural network 206. In some embodiments, knowledge distillation is denoted by a learning operation from the aggregated probability outputs of the ensemble of teachers via a loss term according to the equation (4):

$$L ( {\overline{P}}_{Temp = τ} , σ ( \hat{y} ; Temp = τ ) ) \qquad ( 4 )$$

where the term σ(.; Temp=τ) is the softmax temperature, P̅_{Temp=τ} is the average softened probabilities from the teacher encoders, and L( [symbol] ) is the cross-entropy loss.

The use of soft-label knowledge distillation in this manner further modifies the objective function as described with respect to equation (5):

$${min}_{{θ}_{img} , {θ}_{sensor} , {w}_{0} , {w}_{1} , {w}_{reg}} {λ}_{0} L ( y , σ ( \hat{y} ) ) + {λ}_{1} {\sum }_{i , j = 1}^{\vert {T}^{img} \vert \vert {ϕ}^{img} \vert} {δ}_{i , j} {L}_{distillImg} ( {T}_{i}^{img} , R ( {ϕ}_{j}^{img} ; {w}_{reg} ) ) + {λ}_{2} {L}_{distillEmb} ( , {ϕ}^{sensor} [ {I}^{T} ] ) + {λ}_{3} L ( {\overline{P}}_{Temp = τ} , σ ( \hat{y} ; Temp = τ ) ) \qquad ( 5 )$$

### Step 5: Inference

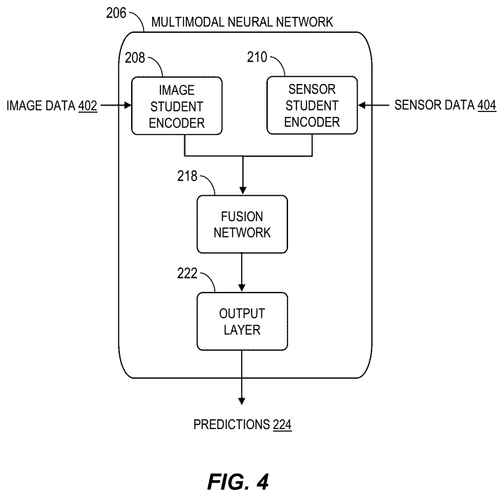

During inference, the trained model (e.g., the multimodal neural network 206) takes in new input data, such as an image and a text description, and generates an output (also referred to as a “prediction 224”). The prediction 224 can include, for example, a predicted label and/or a response to an input text. FIG. 4 illustrates an example inference for the multimodal neural network 206 for image data 402 and sensor data 404 in accordance with one or more embodiments.

During inference, the input data (e.g., image data 402, sensor data 404, etc.) can be pre-processed in the same way as described with respect to model training, and the input data (pre-processed or not) can then be fed through the model's trained layers to generate the prediction 224. In some cases, the input data can be pre-processed in a different way during inference than was used during training, such as by using a different set of data augmentation techniques for one or both of the image data 402 and the sensor data 404. As further shown in FIG. 4, in some embodiments, the knowledge distillation branches are removed from the multimodal neural network 206 and inference is accomplished as if the multimodal neural network 206 was a standard multimodal neural network.

### Experimental Evaluation

Performance metrics for a multimodal deep learning model with boosted trees configured via joint knowledge distillation in accordance with one or more embodiments was compared against a selection of alternative model architectures. The results are summarized below in Table 1.

TABLE 1
Model Performance Metrics

| | | UCF51 | XD-Violence | Welding |
|---|---|---|---|---|
| | Model | AUPR_pos | AUPR_pos | AUPR_pos |
| Audio only | LightGBM | 0.244 | 0.578 | 0.340 |
| | SnapBoost (SBoost) | 0.472 | 0.577 | 0.182 |
| | Neural Network (NN) | 0.413 | 0.594 | 0.201 |
| | DeepGBM | 0.342 | 0.594 | 0.432 |
| | **DeepSBoost | 0.510 | 0.629 | 0.416 |
| Image only | *Teacher CNN | 0.225 | 0.572 | 0.719 |
| | MobileNetV3 | 0.157 | 0.560 | 0.576 |
| | Distilled MobileNetV3 (soft KD) | 0.110 | 0.574 | 0.702 |
| | Distilled MobileNetV3 (internal KD) | 0.228 | 0.573 | 0.693 |
| | Distilled MobileNetV3 (soft + internal KD) | 0.155 | 0.582 | 0.628 |
| Image + Audio | *Teacher CNN + NN | 0.426 | 0.623 | 0.747 |
| | MobileNetV3 + NN | 0.194 | 0.621 | 0.594 |
| Image + Audio | Our proposed method | 0.629 | 0.645 | 0.795 |

Table 1 illustrates test Area Under Precision-Recall (AUPR) of the positive class across methods. Note that “Teacher CNN” refers to the GoogLeNet for UCF51 and Welding datasets, and to ResNet50 for the XD-Violence dataset. Note further that DeepSBoost refers to an implementation of knowledge distillation of the SnapBoost model to a neural network model. Observe that a multimodal deep learning model configured in accordance with one or more embodiments achieved the highest AUPR of all tested methods.

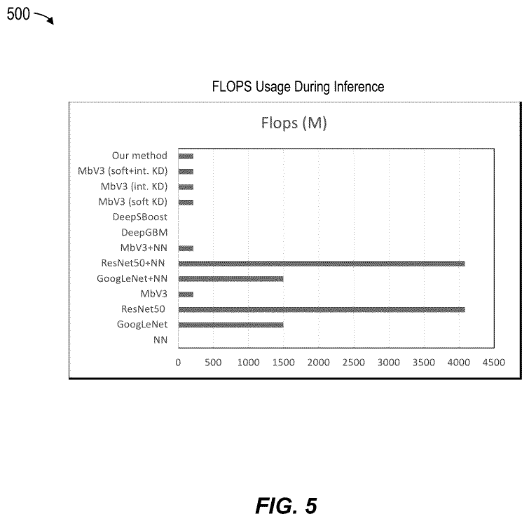

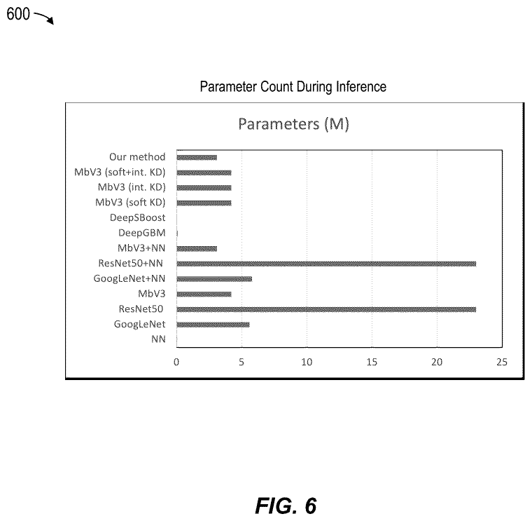

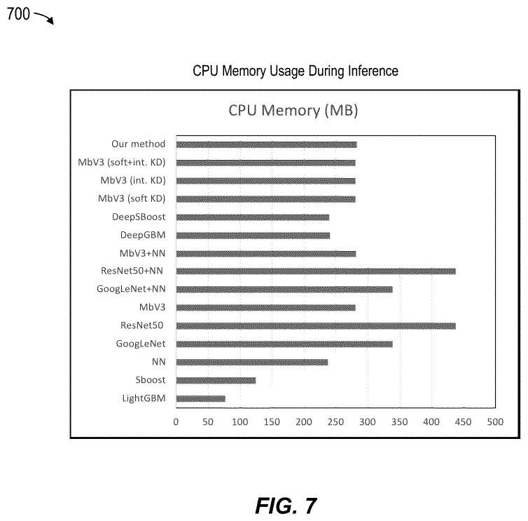

Additional performance metrics are illustrated in FIGS. 5, 6, and 7. FIG. 5 depicts a graph 500 of floating point operations (FLOPS) usage during inference for a variety of machine learning architectures in accordance with one or more embodiments of the present invention. FIG. 6 depicts a graph 600 of parameter count during inference for a variety of machine learning architectures in accordance with one or more embodiments of the present invention. FIG. 7 depicts a graph 700 of CPU memory usage during inference for a variety of machine learning architectures in accordance with one or more embodiments of the present invention. Observe that multimodal deep learning models configured in accordance with one or more embodiments achieved competitive FLOPS usage, parameter count, and CPU memory usage during interference.

Yet more performance metrics are shown in Tables 2 and 3. Table 2 shows test AUPR for multimodal neural networks with knowledge distillation for different numbers of tree groups T and distillation loss terms. Hyperparameters λ₀, λ₁, λ₂, and λ₃ refer to the weight coefficients in equation (5).

TABLE 2
Test AUPR vs. Tree Group Count

| | UCF51 | | XD-Violence | | Welding | |
|---|---|---|---|---|---|---|
| # tree | λ₀; λ₁; | λ₀; λ₁; | λ₀; λ₁; | λ₀; λ₁; | λ₀; λ₁; | λ₀; λ₁; |
| groups | λ₂ | λ₂; λ₃ | λ₂ | λ₂; λ₃ | λ₂ | λ₂; λ₃ |
| 1 | 0.527 | 0.518 | 0.638 | 0.645 | 0.740 | 0.795 |
| 2 | 0.629 | 0.623 | 0.606 | 0.638 | 0.479 | 0.520 |
| 5 | 0.469 | 0.478 | 0.616 | 0.633 | 0.680 | 0.535 |
| 10 | 0.250 | 0.334 | 0.606 | 0.629 | 0.098 | 0.142 |
| 15 | NA | NA | 0.624 | 0.632 | 0.482 | 0.113 |

Table 3 shows test AUPR for multimodal neural networks with knowledge distillation for different numbers of tree groups T and distillation loss terms. Hyperparameters λ₀ and λ₂ refer to the weight coefficients in equation (5).

TABLE 3
Test AUPR vs. Tree Group Count

| # tree | UCF51 | | XD-Violence | | Welding | |
|---|---|---|---|---|---|---|
| groups | λ₀ | λ₀; λ₂ | λ₀ | λ₀; λ₂ | λ₀ | λ₀; λ₂ |
| 1 | 0.451 | 0.493 | 0.621 | 0.610 | 0.740 | 0.756 |
| 2 | 0.255 | 0.580 | 0.624 | 0.612 | 0.571 | 0.534 |
| 5 | 0.361 | 0.478 | 0.615 | 0.620 | 0.644 | 0.676 |
| 10 | 0.356 | 0.271 | 0.615 | 0.622 | 0.121 | 0.129 |
| 15 | NA | NA | 0.655 | 0.617 | 0.324 | 0.312 |

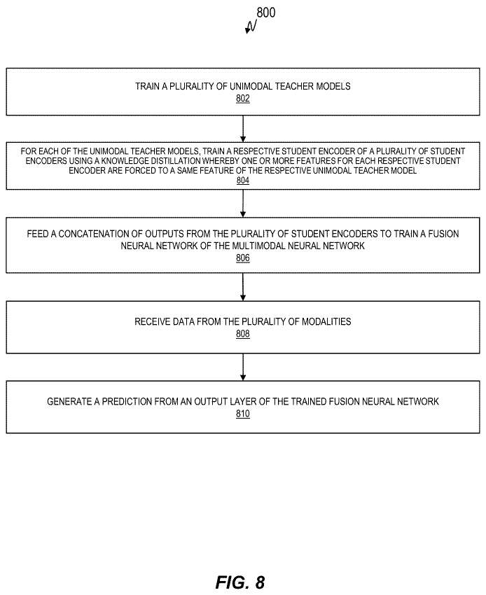

Referring now to FIG. 8, a flowchart 800 for leveraging a joint knowledge distillation-based approach for multimodal deep learning with boosted trees is generally shown according to an embodiment. The flowchart 800 is described in reference to FIGS. 1-7 and may include additional blocks not depicted in FIG. 8. Although depicted in a particular order, the blocks depicted in FIG. 8 can be rearranged, subdivided, and/or combined. In exemplary embodiments, the method 800 can be performed by a computing environment (e.g., computing environment 100 shown in FIG. 1).

At block 802, a plurality of unimodal teacher models is trained. Each unimodal teacher model of the plurality of unimodal teacher models can be trained using training data from a unique modality of a plurality of modalities.

In some embodiments, the plurality of unimodal teacher models includes a convolutional neural network (CNN) teacher and a gradient boosted decision tree (GBDT) teacher. Advantageously, each teacher model can be applied to modalities (e.g., image data and sensor data, respectively) known to be suitable to the respective teacher configuration.

At block 804, for each of the unimodal teacher models, a respective student encoder of a plurality of student encoders is trained using a knowledge distillation such that one or more features for each respective student encoder are forced to a same feature of the respective unimodal teacher model. Note that the student encoders (refer to block 804) and the fusion neural network (refer to block 806), which are both parts of the multimodal neural network, can be trained simultaneously. That is, block 804 and block 806 can be concurrent blocks. In this manner, the student encoders and the fusion network can be optimized jointly.

In some embodiments, each unimodal teacher model is uniquely coupled, directly or indirectly, to a student encoder. Advantageously, this configuration allows each student encoder to be built from a single teacher model of a single modality, further reducing the risk of modality collapse. In some embodiments, the CNN teacher is coupled to an image student encoder and the GBDT teacher is coupled to a sensor student encoder, allowing each respective student encoder to be built from a teacher trained using data from the same modality.

At block 806, a concatenation of outputs from the plurality of student encoders are used to train a fusion neural network of the multimodal neural network. Again, the student encoders (refer to block 804) and the fusion neural network (refer to block 806), which are both parts of the multimodal neural network, can be trained simultaneously.

At block 808, data is received from the plurality of modalities. For example, the data can include image data and/or sensor data, although the data involved is not meant to be particularly limited. At block 810, a prediction is generated from an output layer of the trained fusion neural network.

In some embodiments, a soft-label output is generated from each unimodal teacher model. In some embodiments, knowledge distillation is enforced on the output layer by forcing the output layer to approximate an aggregated probability output (aggregated soft-labels) of the plurality of unimodal teacher models via a loss term of an objective function of the multimodal neural network. Advantageously, enforcing knowledge distillation on the output layer allows for further fine-tuning of the multimodal neural network.

In some embodiments, knowledge distillation includes training a neural network with one or more tree features to approximate a tree group structure of a gradient boosted decision tree (GBDT) teacher. Advantageously, applying knowledge distillation in this manner allows a neural network-based student encoder to be built for a tree-based teacher model at a minimized (within a predefined distance) loss.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for a multimodal neural network comprising:
training a plurality of unimodal teacher models, wherein each unimodal teacher model of the plurality of unimodal teacher models is trained using training data from a unique modality of a plurality of modalities;
for each of the unimodal teacher models, training a respective student encoder of a plurality of student encoders using a knowledge distillation whereby one or more features for each respective student encoder are forced to a same feature of the respective unimodal teacher model;
feeding a concatenation of outputs from the plurality of student encoders to train a fusion neural network of the multimodal neural network;
receiving data from the plurality of modalities; and
generating a prediction from an output layer of the trained fusion neural network.

2. The computer-implemented method of claim 1, wherein each unimodal teacher model is uniquely coupled, directly or indirectly, to a student encoder.

3. The computer-implemented method of claim 2, wherein the plurality of unimodal teacher models comprises a convolutional neural network (CNN) teacher and a gradient boosted decision tree (GBDT) teacher.

4. The computer-implemented method of claim 3, wherein the CNN teacher is coupled to an image student encoder and the GBDT teacher is coupled to a sensor student encoder.

5. The computer-implemented method of claim 1, further comprising generating, from each unimodal teacher model, a soft-label output.

6. The computer-implemented method of claim 5, further comprising enforcing knowledge distillation on the output layer of the multimodal neural network by forcing the output layer to approximate an aggregated probability output of the plurality of unimodal teacher models via a loss term of an objective function of the multimodal neural network.

7. The computer-implemented method of claim 1, wherein knowledge distillation comprises training a neural network with one or more tree features to approximate a tree group structure of a gradient boosted decision tree (GBDT) teacher.

8. A system having a memory, computer readable instructions, and one or more processors for executing the computer readable instructions, the computer readable instructions controlling the one or more processors to perform operations comprising:
training a plurality of unimodal teacher models, wherein each unimodal teacher model of the plurality of unimodal teacher models is trained using training data from a unique modality of a plurality of modalities;
for each of the unimodal teacher models, training a respective student encoder of a plurality of student encoders using a knowledge distillation whereby one or more features for each respective student encoder are forced to a same feature of the respective unimodal teacher model;
feeding a concatenation of outputs from the plurality of student encoders to train a fusion neural network of the multimodal neural network;
receiving data from the plurality of modalities; and
generating a prediction from an output layer of the trained fusion neural network.

9. The system of claim 8, wherein each unimodal teacher model is uniquely coupled, directly or indirectly, to a student encoder.

10. The system of claim 9, wherein the plurality of unimodal teacher models comprises a convolutional neural network (CNN) teacher and a gradient boosted decision tree (GBDT) teacher.

11. The system of claim 10, wherein the CNN teacher is coupled to an image student encoder and the GBDT teacher is coupled to a sensor student encoder.

12. The system of claim 8, further comprising generating, from each unimodal teacher model, a soft-label output.

13. The system of claim 12, further comprising enforcing knowledge distillation on the output layer by forcing the output layer of the multimodal neural network to approximate an aggregated probability output of the plurality of unimodal teacher models via a loss term of an objective function of the multimodal neural network.

14. The system of claim 8, wherein knowledge distillation comprises training a neural network with one or more tree features to approximate a tree group structure of a gradient boosted decision tree (GBDT) teacher.

15. A computer program product comprising a computer readable storage medium having program instructions embodied therewith, the program instructions executable by one or more processors to cause the one or more processors to perform operations comprising:
training a plurality of unimodal teacher models, wherein each unimodal teacher model of the plurality of unimodal teacher models is trained using training data from a unique modality of a plurality of modalities;
for each of the unimodal teacher models, training a respective student encoder of a plurality of student encoders using a knowledge distillation whereby one or more features for each respective student encoder are forced to a same feature of the respective unimodal teacher model;
feeding a concatenation of outputs from the plurality of student encoders to train a fusion neural network of the multimodal neural network;
receiving data from the plurality of modalities; and
generating a prediction from an output layer of the trained fusion neural network.

16. The computer program product of claim 15, wherein each unimodal teacher model is uniquely coupled, directly or indirectly, to a student encoder.

17. The computer program product of claim 16, wherein the plurality of unimodal teacher models comprises a convolutional neural network (CNN) teacher and a gradient boosted decision tree (GBDT) teacher.

18. The computer program product of claim 17, wherein the CNN teacher is coupled to an image student encoder and the GBDT teacher is coupled to a sensor student encoder.

19. The computer program product of claim 15, further comprising generating, from each unimodal teacher model, a soft-label output.

20. The computer program product of claim 19, further comprising enforcing knowledge distillation on the output layer by forcing the output layer of the multimodal neural network to approximate an aggregated probability output of the plurality of unimodal teacher models via a loss term of an objective function of the multimodal neural network.
